(19) United States
(12) Patent Application Publication
(10) Pub. No.: US 2013/0028332 A1
(43) Pub. Date: Jan. 31, 2013

(54) Method and device for parallel decoding of scalable bitstream elements

(71) Applicants: Fabrice LE LEANNEC, MOUAZE (FR); Naël OUEDRAOGO, Maure de Bretagne (FR); Julien RICARD, RENNES (FR)

(72) Inventors: Fabrice LE LEANNEC, MOUAZE (FR); Naël OUEDRAOGO, Maure de Bretagne (FR); Julien RICARD, RENNES (FR)

(73) Assignee: CANON KABUSHIKI KAISHA, Tokyo (JP)

(21) Appl. No.: 13/560,824

(22) Filed: Jul. 27, 2012

(30) Foreign Application Priority Data
Jul. 29, 2011 (GB) GB1113111.7

(51) Int. Cl. H04N 7/26

(52) U.S. Cl. 375/240.25; 375/240.29; 375/E07.19; 375/E07.027

(57) ABSTRACT

A deblocking filter that deblocks an already-decoded video bitstream made up of pictures, which are themselves made up of slices and lines of blocks (the slices and lines not necessarily having the same number of blocks). A multi-core processor performs both decoding and deblocking. After decoding, a message is created indicating which blocks in which slices have been decoded. As the decoding has been performed in parallel on parallel cores, the blocks are not necessarily in sequential order. Messages are received and re-ordered by a deblocking filter and when a sequence (preferably a line) of blocks has been decoded, the deblocking filter takes on some of the cores and uses them to deblock the sequentially-ordered blocks. If there is only one slice in a picture, messages indicate to the deblocking filter when a full line of blocks has been received.

### CROSS-REFERENCE TO RELATED APPLICATIONS

This application claims the benefit under 35 U.S.C. §119(a)-(d) of UK Patent Application No. 1113111.7, filed on Jul. 29, 2011 and entitled “Method and device for parallel decoding of scalable bitstream elements”.

The above cited patent application is incorporated herein by reference in its entirety.

### FIELD OF THE INVENTION

The present invention relates to decoders for decoding video data such as video streams of the H.264/AVC or SVC type. In particular, the present invention relates to H.264 decoders, including scalable video coding (SVC) decoders and their architecture, and to the decoding tasks that are carried out on the video data encoded using the H.264/AVC and H.264/SVC specifications.

H.264/AVC (Advanced Video Coding) is a standard for video compression providing good video quality at a relatively low bit rate. It is a block-oriented compression standard using motion-compensation algorithms. In other words, the compression is carried out on video data that has effectively been divided into blocks, where a plurality of blocks usually makes up a video frame. A block can be either spatially predicted (i.e. blocks are predicted from neighbouring blocks in the same picture) or temporally predicted (i.e. blocks are predicted from reference blocks in a neighbouring picture). The block is then encoded in the form of a syntax element designating the data used for prediction and residual data representing the error (or difference) between the prediction and the original data. Note that transformation, quantization and entropy encoding are successively applied to the residual data. The standard has been developed to be easily used in a wide variety of applications and conditions.

An extension of H.264/AVC is SVC (Scalable Video Coding) which encodes a high quality video bitstream by dividing it into a plurality of scalability layers containing subset bitstreams. Each subset bitstream is derived from the main bitstream by filtering out parts of the main bitstream to give rise to subset bitstreams of lower spatial or temporal resolution or lower quality video than the full high quality video bitstream. In this way, if bandwidth becomes limited, individual bitstreams can be discarded, merely causing a less noticeable degradation of quality rather than complete loss of picture.

Functionally, the compressed video comprises a base layer containing basic video information, and enhancement layers that provide additional information about quality, resolution or frame rate. It is these enhancement layers that may be discarded in the attempt to balance high compression speed with low file size and high quality video data.

The algorithms that are used for compressing the video data stream deal with three main frame types: I, P and B frames.

An I-frame is an “Intra-coded picture” and contains all of the information required to display that picture. In the H.264 standard, blocks in I frames are encoded using intra prediction. Intra prediction consist of predicting the pixels of a current block from encoded/decoded pixels at the external boundary of the current block. The block is then encoded in the form of an Intra-prediction direction and a residual (the residual representing the error between the current block and the boundary pixels). I-frames are the least compressible of the frame types but do not require other types of frames in order to be decoded and to produce a full picture.

A P-frame is a “predicted picture” and holds only the changes in the picture from at least a previously-encoded frame. P-frames can use data from previous frames to be compressed and are more compressible than I-frames for this reason. A B-frame is a “Bi-predictive picture” and holds changes between the current picture and both a preceding picture and a succeeding picture to specify its content. As B-frames can use both preceding and succeeding frames for data reference to be compressed, B-frames are the most compressible of the frame types. P- and B-frames are collectively referred to as “Inter” frames. Blocks from P- and B-frames are encoded in the form of an Inter-prediction direction and a residual, the residual representing the error between the current block and a reference area in the previously-encoded or successively-encoded frame.

Pictures may be divided into slices. A slice is a spatially distinct region of a picture that is encoded separately from other regions of the same picture. Furthermore, pictures can be segmented into macroblocks. A macroblock is a type of block referred to above and may comprise, for example, each 16×16 array of pixels of each coded picture. I-pictures contain only I-macroblocks. P-pictures may contain either I-macroblocks or P-macroblocks and B-pictures may contain any of I-, P- or B-macroblocks. Sequences of macroblocks may make up slices. Macroblocks are generally processed in an order that starts at the top left of a picture, scanned across a horizontal line and starts at the left side of a second line down, etc., to the bottom right corner of the picture. The size of a line is dependent on the size of a picture, as it is a horizontal line of macroblocks that extends across the whole picture. The size of a macroblock is dependent on how it has been defined (i.e. the number of pixels) and the size of a slice is unspecified and left to the implementer.

Pictures (also known as frames) may be individually divided into the base and enhancement layers described above.

Inter-macroblocks (i.e. P- and B-macroblocks) correspond to a specific set of macroblocks that are formed in block shapes specifically for motion-compensated prediction. In other words, the size of macroblocks in P- and B-pictures is chosen in order to optimise the prediction of the data in that macroblock based on the extent of the motion of features in that macroblock compared with previous and/or subsequent reference areas.

When a video bitstream is being manipulated (e.g. transmitted or encoded, etc.), it is useful to have a means of containing and identifying the data. To this end, a type of data container used for the manipulation of the video data is a unit called a Network Abstraction Layer unit (NAL unit or NALU). A NAL unit—rather than being a physical division of the picture as the macroblocks described above are—is a syntax structure that contains bytes representing data, an indication of a type of that data and whether the data is the video or other related data. Different types of NAL unit may contain coded video data or information related to the video. Each scalable layer corresponds to a set of identified NAL units. A set of successive NAL units that contribute to the decoding of one picture forms an Access Unit (AU).

FIG. 1 illustrates a typical decoder 100 attached to a network 34 for communicating with other devices on the network. The decoder 100 may take the form of a computer, a mobile (cell) telephone, or similar. The decoder 100 uses a communication interface 118 to communicate with the other devices on the network (other computers, mobile telephones, etc.). The decoder 100 also has optionally attachable or attached to it a microphone 124, a floppy disk 116 and a digital card 101, via which it receives auxiliary information such as information regarding a user's identification or other security-related information, and/or data processed (in the floppy disk or digital card) or to be processed by the decoder. The decoder itself contains interfaces with each of the attachable devices mentioned above; namely, an input/output 122 for audio data from the microphone 124 and a floppy disk interface 114 for the floppy disk 116 and the digital card 101. The decoder will also have incorporated in, or attached to, it a keyboard 110 or any other means such as a pointing device, for example, a mouse, a touch screen or remote control device, for a user to input information; and a screen 108 for displaying video data to a user or for acting as a graphical user interface. A hard disk 112 will store video data that is processed or to be processed by the decoder. Two other storage systems are also incorporated into the decoder, the random access memory (RAM) 106 or cache memory for storing registers for recording variables and parameters created and modified during the execution of a program that may be stored in a read-only memory (ROM) 104. The ROM is generally for storing information required by the decoder for decoding the video data, including software for controlling the decoder. A bus 102 connects the various devices in the decoder 100 and a central processing unit (CPU) 103 controls the various devices.

FIG. 2 is a conceptual diagram of the SVC decoding process that applies to an SVC bitstream 200 made, in the present case, of three scalability layers. More precisely, the SVC bitstream 200 being decoded in FIG. 2 is made of one base layer (the related decoding process appears with the suffix “a” in FIG. 2), a spatial enhancement layer (the related decoding process appears with the suffix “b” in FIG. 2), and an SNR (signal to noise ratio) enhancement layer (or quality layer) on top of the spatial layer (the related decoding process appears with the suffix “c” in FIG. 2). Therefore, the SVC decoding process comprises three stages, each of which handles items of data of the bitstream according to the layer to which they belong. To that end, a demultiplexing operation 202 is performed by a demultiplexer on the received items of data to determine in which stage of the decoding method they should be processed.

The first stage (with suffix “a” in the reference numerals) illustrated in FIG. 2 concerns the base layer decoding process that starts by the parsing and entropy decoding 204a of each macroblock within the base layer. The apparatus and process for decoding H.264/AVC encoded bitstreams that are single-layered would be only the base layer decoding apparatus and process labelled “a”. In other words, H.264/AVC does not deal with encoding enhancement layers.

The entropy decoding process provides a coding mode, motion data and residual data. The motion data contains reference picture indices for Inter-coded or Inter-predicted macroblocks (i.e. an indication of which pictures are the reference pictures for a current picture including the Inter-coded macroblocks) and motion vectors defining transformation from the reference-picture areas to the current Inter-coded macroblocks. The residual data consists of the difference between the macroblock to be decoded and the reference area (from the reference picture) indicated by the motion vector, which has been transformed using a discrete cosine transform (DCT) and quantised during the encoding process. This residual data can be stored as the encoded data for the current macroblock, as the rest of the information defining the current macroblock is available from the corresponding reference area.

This same parsing and entropy decoding step 204b, 204c is also performed to the two enhancement layers, in the second (b) and third (c) stages of the process.

Next, in each stage (a,b,c), the quantised DCT coefficients that have been revealed during the entropy decoding process 204a, 204b, 204c undergo inverse quantisation and inverse transform operations 206a, 206b, 206c. In the example of FIG. 2, the second layer of the stream has a higher spatial resolution than the base layer. In SVC, the residual data is completely reconstructed in layers that precede a resolution change because the texture data undergoes a spatial up-sampling process. Thus, the inverse quantisation and transform is performed on the base layer to reconstruct the residual data in the base layer as it precedes a resolution change (to a higher spatial resolution) in the second layer.

With reference specifically to the first stage (a) of processing the base layer, the decoded motion and temporal residual data for Inter-macroblocks and the reconstructed Intra-macroblocks are stored into a frame buffer 208a of the SVC decoder of FIG. 2. Such a frame buffer contains the data that can be used as reference data to predict an upper scalability layer during inter-layer prediction.

To improve the visual quality of decoded video, deblocking filters 212, 214 are applied for smoothing sharp edges formed between decoded blocks. The goal of the deblocking filter, in an H.264/AVC or SVC decoder, is to reduce the blocking artefacts that may appear on the boundaries of decoded blocks. It is a feature on both the decoding and encoding paths, so that in-loop effects of the deblocking filter are taken into account in the reference pictures.

The inter-layer prediction process of SVC applies a so-called Intra-deblocking operation 212 on Intra-macroblocks reconstructed from the base layer of FIG. 2. The Intra-deblocking consists of filtering the blocking artefacts that may appear at the boundaries of reconstructed Intra-macroblocks and that may give those macroblocks a “block-like” or “sharp-edged” appearance which means that the image luminance does not progress smoothly from one macroblock to the next. This Intra-deblocking operation occurs in the Inter-layer prediction process only when a spatial resolution change occurs between two successive layers (so that the full Inter-layer prediction data is available prior to the resolution change). This may, for example, be the case between the first (base) and second (enhancement) layers in FIG. 2.

With reference specifically to the second stage (b) of FIG. 2, the decoding is performed of a spatial enhancement layer on top of the base layer decoded by the first stage (a). This spatial enhancement layer decoding involves the parsing and entropy decoding of the second layer, which provides the motion information as well as the transformed and quantised residual data for macroblocks of the second layer. With respect to Inter-macroblocks, as the next layer (third layer) has the same spatial resolution as the second one, their residual data only undergoes the entropy decoding step and the result is stored in the frame memory buffer 208b associated with the second layer of FIG. 2.

A residual texture refinement process is performed in the transform domain between quality layers in SVC. Quality is measured by SNR (signal to noise ratio). There are two types of quality layers currently defined in SVC, namely CGS layers (Coarse Grain Scalability) and MGS layers (Medium Grain Scalability).

Concerning Intra-macroblocks, their processing depends upon their type. In case of inter-layer-predicted Intra-macroblocks (using an I_BL coding mode that produces Intra-macroblocks using inter-layer predictions), the result of the entropy decoding is stored in the respective frame memory buffer 208b. In the case of a non-I_BL Intra-macroblock, such a macroblock is fully reconstructed through inverse quantisation and inverse transform 206 to obtain the residual data in the spatial domain, and then Intra-predicted 210b.

Intra-coded macroblocks are fully reconstructed through the well-known spatial Intra-prediction techniques 210a, 210b, 210c. However, Inter-layer prediction (i.e. prediction from a lower layer) and a texture refinement process can be applied directly on quantised coefficients without performing inverse quantisation in the case of a quality enhancement layer (c), depending on whether information from lower layers is available. In FIG. 2, the output of the Intra-Deblocking 212 from the lower layer being input into the respective enhancement layer prediction step is represented by the switch 230 being connected to the top-most connection and thus connecting the full deblocking step 214 of the enhancement layer to the Intra-deblocking module 212.

Finally, the decoding of the third layer of FIG. 2, which is also the top-most layer of the presently-considered bitstream, involves a motion compensated (218) temporal prediction loop. The following successive steps are performed by the decoder to decode the sequence at the top-most layer. These steps may be summed up as parsing & decoding; reconstruction; deblocking and interpolation.
Each macroblock first undergoes a parsing and entropy decoding process 204c which provides motion and texture residual data for inter-macroblocks and prediction direction and texture residual for intra-macroblocks. If inter-layer residual prediction is used for the current macroblock, further quantised residual data is used to refine the quantised residual data issued from the reference layer. This is shown by the bottom connection of switch 230. Texture refinement is performed in the transform domain between layers. In SVC, one can predict texture data of a current layer from a lower layer, even one that has a lower spatial resolution. This takes place in the scaling module 206c.
A reconstruction step is performed by applying an inverse quantisation and inverse transform 206c to the optionally refined residual data. This provides reconstructed residual data.
   In the case of Inter-macroblocks, the decoded residual data refines the decoded residual data that issued from the base layer if inter-layer residual prediction was used to encode the second scalability layer.
   In the case of Intra-macroblocks in I_BL mode, the decoded residual data is used to refine the residual data of the base macroblock.
The decoded residual data (which is refined or not depending on the type of inter-layer prediction) is then added to the predictor obtained either by temporal prediction or Intra-prediction, to provide the reconstructed macroblock. The I_BL Intra-macroblocks are output from the inter-layer prediction based on lower layers and this output is represented by the arrow from the deblocking filter 212 to the tri-connection switch 230.
The reconstructed macroblock undergoes a so-called full deblocking filtering process 214, which is applied both to Inter- and Intra-macroblocks. This is in contrast to the deblocking filter 212 applied in the base layer which is applied only to Intra-macroblocks.
The full deblocked picture is then stored in the Decoded Picture Buffer (DPB), represented by the frame memory 208c in FIG. 2, which is used to store pictures that will be used as references to predict future pictures to decode. The decoded pictures are also ready to be displayed on a screen.
Then frames in the DPB are interpolated when they are used for reference for the reconstruction of future frames which are obtained by a sub-pixel motion compensation process.

The reconstructed residual data is then stored in the frame buffers 208a, 208b, 208c in each stage.

The deblocking filters 212, 214 are filters applied in the decoding loop, and they are designed to reduce the blocking artefacts and therefore to improve the visual quality of the decoded sequence. For the topmost decoded layer, the full deblocking comprises an enhancement filter applied to all blocks with the aim of improving the overall visual quality of the decoded picture. This full deblocking process, which is applied on complete reconstructed pictures, is the same adaptive deblocking process specified in the H.264/AVC compression standard.

US 2006/0556161 A1 and US 2009/0307464 describe video decoding using a multithread processor. US 2006/0556161 A1 in particular describes analysing the temporal dependencies between images in terms of reference frames through the slice type to allocate time slots. Frames of the video data are read and decoded in parallel in different threads. Temporal dependencies between frames are analysed by reading the slice headers. Time slots are allocated during which the frames are read or decoded. Different frames contain different amounts of data and so even though all tasks are started at the same time (at the beginning of a time slot), some tasks can be performed faster than others. Threads processing faster tasks will therefore stand idle while slower tasks are processed. US 2009/0307464 discusses in particular the use of master and slave threads in the multithread processor.

Generally, SVC or H.264 bitstreams are organised in the order in which they will be decoded. This means that in the case of a sequential decoding (NALU per NALU), decoding in a single elementary decoder means that the content does not need to be analysed. This is the case of the JSVM reference software for SVC and for the JM reference software of H.264.

The problem with the above-described methods is that the decoders are idle while they wait for the processing stages of each of the layers of the video data to be completed. This gives rise to an inefficient use of processing availability of the decoder. A further problem is that the method is limited by the fact that the output of a preceding layer is used for the decoding of a current layer, the output of which is required for the decoding of the subsequent layer and so on. Furthermore, the decoders always wait for a full NAL unit to be decoded before extracting the next NAL unit for decoding, thus increasing their idle time and thus decreasing throughput.

A solution to the idleness of decoders was proposed in U.S. Ser. No. 12/775,086. In that document, the various decoding tasks (entropy decoding or parsing, inverse quantisation and inverse direct cosine transform (iDCT)) are performed in parallel by different decoder units in different cores of a multi-core processor. Each NAL unit is allocated to a separate decoder unit as and when it is appropriate for the next decoding task to be performed on it, the allocation being made based on constraints of the hardware and of the decoding process. For example, the decoding tasks are performed in a specific order within each layer and a first layer has to be decoded and parsed before a second layer can be started. However, a limitation with this allocation to various decoder units is that deblocking (212 and 214 in FIG. 2) cannot be included in this solution because deblocking can only be performed after all of the other decoding processes have been performed and the slices must be deblocked sequentially, rather than in parallel. Thus, even if decoding and parsing are able to be performed in parallel slice by slice, the duration of the total decoding process is limited by the sequential deblocking of slices.

US 2008/0159407 and US 2008/0298473 discuss the synchronisation of threads on which to perform deblocking of lines of macroblocks. The synchronisation is limited to checking whether macroblocks to be deblocked have satisfied certain conditions such as having an immediate left neighbour and an upper-right diagonal neighbour that have already been deblocked. This does not deal with how to use threads more efficiently.

An object of the present invention is to decrease the amount of time required for the decoding of a video bitstream by finding a way to perform deblocking filtering on a decoded video bitstream layer more efficiently. Specifically, a problem addressed by the present invention is how to increase the deblocking filter (DBF) speed in the case of multiple slices and parallel slice parsing/decoding.

### SUMMARY OF THE INVENTION

According to a first aspect of the invention, there is provided a deblocking filter for deblocking a decoded video bitstream comprising a plurality of pictures, each picture comprising a plurality of blocks, the deblocking filter comprising: a plurality of deblocking filter units; receiving means for receiving information indicating that a plurality of blocks have been decoded; and distribution means for determining whether a predetermined number of blocks have been decoded and for distributing, amongst at least one of the plurality of deblocking filter units, messages regarding deblocking the decoded blocks when it is determined that all blocks of the predetermined number of blocks have been decoded; wherein the plurality of deblocking filter units are configured to deblock the decoded blocks according to the distributed messages. Generally, each picture comprises a plurality of lines of blocks and so the predetermined number of blocks preferably comprises such a line of blocks.

According to a second aspect of the invention, there is provided a deblocking filter for deblocking a decoded video bitstream comprising a plurality of pictures, each picture comprising a plurality of lines of blocks, the blocks having a predefined sequence, the deblocking filter comprising: a plurality of deblocking filter units; receiving means for receiving information indicating that a plurality of blocks have been decoded; ordering means for ordering the received information according to the predefined sequence of the blocks; distribution means for generating a plurality of messages indicating the order of the ordered, received information and for distributing the messages amongst the deblocking filter units; wherein the plurality of deblocking filter units are configured to deblock the decoded blocks according to the order of the ordered, received information indicated in the messages.

The first aspect of the invention is of particular use when a picture contains only one slice, as the order of the deblocking is less critical than when there are several slices in a picture that are preferably decoded in order. This latter case is dealt with by the second aspect of the invention.

The messages are preferably distributed to the deblocking filter units only when the receiving means has received information indicating that a full line of blocks has been decoded and when the ordering means has ordered the received information for the full line of blocks.

The deblocking filter of either aspect of the invention preferably comprises a main deblocking filter unit and at least one subordinate deblocking filter unit, the main deblocking filter unit including the receiving means, the ordering means (in the case of the second aspect of the invention) and the distribution means and being configured to distribute the messages to the active subordinate deblocking filter units, each of which is configured to deblock a sequence of blocks according to a received message. The number of active subordinate deblocking filter units may be variable. Furthermore, the number of active subordinate deblocking filter units may be dependent on a number of cores available in a multi-core processor. Preferably, if a subordinate deblocking filter unit is not available, the main deblocking filter unit is configured to store the messages until a subordinate deblocking filter unit becomes available.

The information that is received by the receiving means preferably comprises decoder messages from a decoder that has decoded the blocks, the decoder messages containing at least a number of blocks that have been decoded and location in a picture of those decoded blocks, and the ordering means is preferably configured to order the decoder messages in a sequence according to the location in the picture of the decoded blocks (i.e. according to the order in which they appear in the picture).

According to a third aspect of the invention, there is provided a decoder for decoding a video bitstream comprising a plurality of pictures each comprising lines of blocks, the decoder comprising: a plurality of decoder units configured to carry out a plurality of decoding tasks on said blocks in parallel; determining means for determining when a plurality of blocks have been decoded by at least one of the plurality of decoder units; transmission means for transmitting information regarding the blocks that have been decoded to a deblocking filter; and a deblocking filter as described herein.

The plurality of decoder units are preferably configured to create the information that is transmitted by the transmission means, the information comprising messages that indicate at least a number of blocks that have been decoded and a location in a picture of the decoded blocks. Furthermore, the decoding units and the deblocking filter units preferably both use cores in a multi-core processor for performing decoding tasks and deblocking respectively, and the decoder thus further comprises: allocation means for allocating each active core to either a decoding unit or a deblocking filter unit in accordance with a number of blocks that remain to be decoded or deblocked respectively.

The “blocks” herein described are preferably macroblocks.

The decoder is preferably adapted to decode a video bitstream that is encoded according to a scalable format comprising at least two layers, the decoding of a second layer being dependent on the decoding of a first layer, said layers being composed of said blocks and the decoding and deblocking of at least one of said blocks being dependent on the decoding and deblocking of at least one other block, wherein the distribution means is thus preferably configured to distribute messages to the deblocking filter units in an order dependent on the decoded blocks being in the same layer. The decoder is preferably an SVC decoder.

According to a fourth aspect of the invention, there is provided a method of deblocking a decoded video bitstream comprising a plurality of pictures each comprising a plurality of blocks, the method comprising: receiving information indicating that a plurality of blocks have been decoded; determining whether a predetermined number of blocks have been decoded; generating messages regarding deblocking the decoded blocks when it is determined that all blocks of the predetermined number of blocks have been decoded; distributing the messages amongst at least two deblocking filter units; and deblocking the sequence of blocks according to the messages.

According to a fifth aspect of the invention, there is provided a method of deblocking a decoded video bitstream comprising a plurality of pictures each comprising lines of blocks, the blocks having a predefined sequence in each line, the method comprising: receiving information indicating that a plurality of blocks have been decoded; ordering the received information according to the predefined sequence of blocks in a line; generating messages indicating the order of the ordered, received information; distributing the messages amongst at least two deblocking filter units; and deblocking the decoded blocks using the at least two deblocking filter units based on the order indicated in the messages.

According to a sixth aspect of the invention, there is provided a method of decoding a video bitstream comprising a plurality of pictures each comprising lines of blocks, the blocks having a predefined sequence in each line, the method comprising: performing a plurality of decoding tasks on said blocks in parallel; generating information indicating that a plurality of blocks have been decoded; ordering the information according to the predefined sequence of blocks in a line; distributing messages regarding the decoded blocks that form the predefined sequence amongst at least two deblocking filter units; deblocking the sequence of blocks in the at least two deblocking filtering units.

### BRIEF DESCRIPTION OF THE DRAWINGS

FIG. 1 depicts the architecture of a decoder;

FIG. 2 is a schematic diagram of the decoding process of an SVC bitstream;

FIG. 3 is a schematic diagram of the adaptive deblocking filter in H.264/AVC and SVC;

FIG. 4 depicts a parallelised slice decoding process;

FIG. 5 depicts the parallel decoding of multiple slices;

FIG. 6 depicts the decoding of macroblocks and the sending of messages to the deblocking filter units regarding the decoded macroblocks according to an embodiment of the present invention;

FIG. 7 depicts a macroblock-based synchronisation process according to an embodiment;

FIG. 8 is a flow diagram illustrating a main function of a decoding thread according to an embodiment of the present invention;

FIGS. 9 and 10 depict flow diagrams illustrating main and subordinate deblocking thread functions; and

FIGS. 11A and 11B depict load balancing between threads according to embodiments of the present invention.

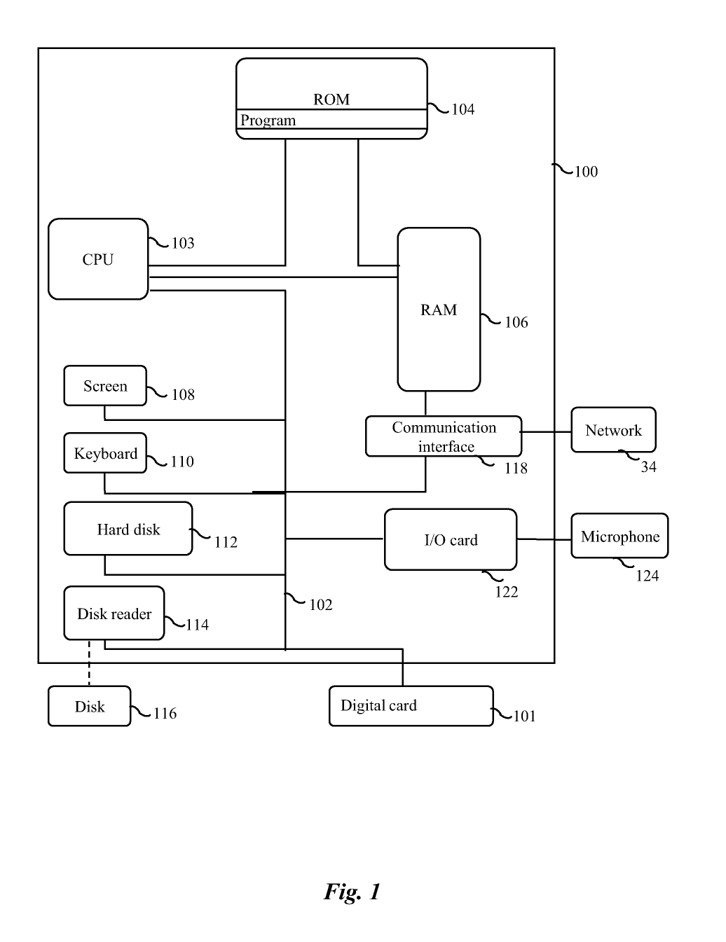

### DETAILED DESCRIPTION OF THE PREFERRED EMBODIMENTS

The specific embodiment below will describe the decoding process of a video bitstream that has been encoded using scalable video coding (SVC) techniques. However, the same process may be applied to an H-264/AVC system.

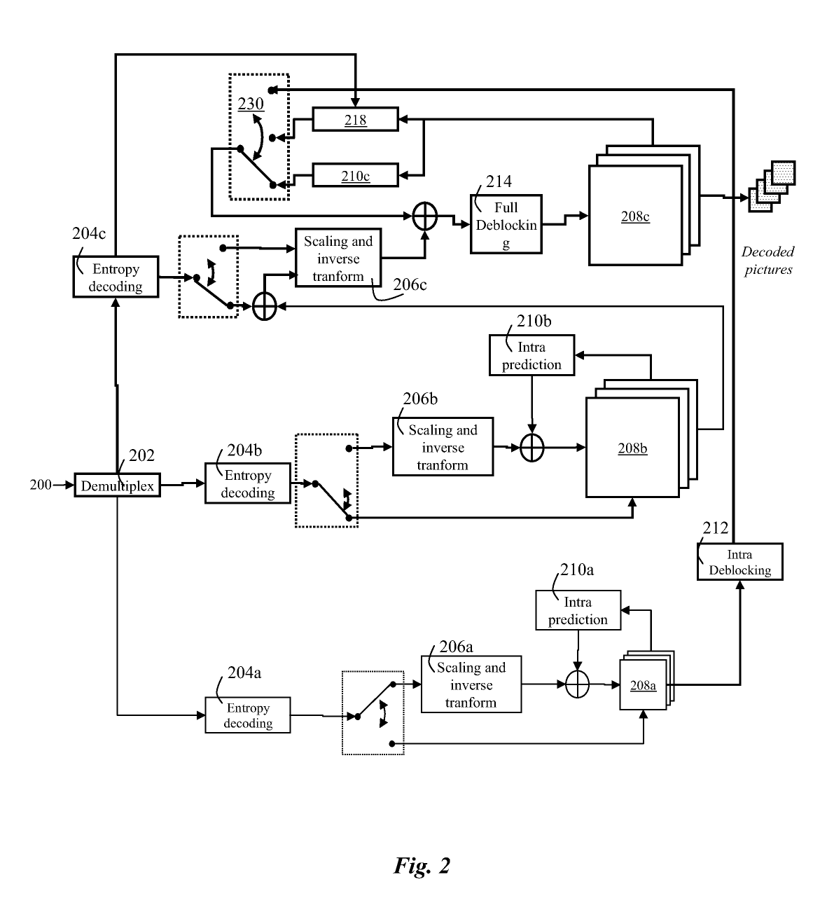

A video data stream (or bitstream) encoder, when encoding a video bitstream, creates packets or containers that contain the data from the bitstream (or information regarding the data) and an identifier for identifying the data that is in the container. These containers are referred to herein generally as video data units and may be, for example, blocks, macroblocks or NAL units. When the video data stream is decoded, the video data units are received and read by a decoder. The various decoding steps are then carried out on the video data units depending on what data is contained within the video data unit. For example, if the video data unit contains base layer data, the decoding processes (or tasks) of stage (a) described above with reference to FIG. 2 will be performed on it.

The decoder of this embodiment is an H.264/AVC decoder with the SVC extension capability, referred to hereinafter as an SVC decoder. Such a decoder would previously have decoded NAL units individually and sequentially. However, it has been noticed that this means that processors experience a large proportion of idle time. As part of a solution to this problem of idle time, the present embodiment uses a multicore processor in the decoder, in which several processes can be executed in parallel in multiple threads. Alternatively, multiple threads may be simulated using software only. In the description below, the combination of hardware and software that together enables multiple threads to be used for decoding tasks will be referred to as individual decoder units. These decoder units are controlled by a decoder controller that keeps track of the synchronisation of the tasks performed by the decoder units.

However, solving the problem of an inefficiently-used processor is not as straightforward as simply processing more than one NALU simultaneously in different threads. The processing of a video bitstream is limited by at least one strict decoding constraint, as described below. The constraints are generally a result of an output of one decoding task being required before a next task may be performed. A decoding task, as referred to herein, is a step in each of the decoding stages (a,b,c) described above in conjunction with FIG. 2.

When the bitstream is encoded for transmission, various compression and encoding techniques may be implemented. For ease of description, the decoding of such encoded NAL units will focus on the following four steps or tasks:

1. Parsing and (entropy) decoding;

2. Reconstruction;

3. Deblocking; and

4. Interpolation.

The first three of these four tasks is carried out on each NAL unit in order to decode the NAL unit completely. The fourth step, interpolation, is carried out only on the NAL units of the top-most enhancement layer.

As mentioned above, the decoding tasks cannot simply be carried out in parallel in multiple threads. The decoder has constraints based on the NAL unit processing order (i.e. video data unit processing constraints) and on the capabilities of the decoder, such as number of cores, number of available threads, memory and processor capacity, etc. (i.e. decoder hardware architecture constraints).

The decoding tasks and their relevance to embodiments of the present invention will now be discussed.

The present embodiments deal with a parallelised software video decoder.

This decoder implements both an H.264 and an SVC decoder. In this considered H.264/AVC and SVC decoder implementation, a degree of parallelism is implemented through the use of threads. The multiple threads contained in that initial version of the decoder include the following ones.
The entropy decoding, called parsing in the remainder of this document.
The macroblock reconstruction process, called decoding herein. This step includes the inverse quantisation, inverse transform, motion compensation and the adding of the decoding residual (temporal texture prediction error) to the motion compensated reference macroblock. Similarly, the simpler reconstruction of Intra-predicted macroblocks without motion compensation and residual.
The deblocking filtering, performed by the so-called deblocking thread, aims at reducing the blocking artefacts inherent to every hybrid block-based video compression system.

In each slice, these threads run in parallel and are pipelined on a basis of lines of macroblocks. This means when the parsing thread had finished processing a line of macroblocks, then it informs the decoding thread that this line of macroblocks is ready for being decoded. In the same way, when the decoding thread has finished processing a line of macroblocks, it tells the deblocking thread that this line of macroblocks is ready to be deblocked. These three threads wait for an available line of macroblocks ready to be processed and then process it when it is ready. Moreover, in that initial decoder implementation, slices in a picture are processed one after another in a sequential way.

To optimise the decoder speed, in pictures containing multiple slices, slices are processed in parallel. Therefore, one parsing thread and one decoding thread are created for each slice, and slices are parsed/decoded in parallel. With respect to the deblocking filter, it cannot be applied to each slice in parallel according to the H.264/SVC standards specifications (see the Advanced Video Coding for Generic Audiovisual Services, ITU-T Recommendation H.264, November 2007).

As a result, a slight speed up of the picture decoding is obtained with the parallel parsing/decoding of each slice. However, this results in an almost sequential functioning of the deblocking filter. Indeed, when all the slices are parsed and deblocked, the deblocking thread becomes the only active thread running on the considered picture until all the deblocking is performed. As a result, because of the parallelised slice parsing/decoding, the deblocking filter becomes, by far, the speed bottleneck of the picture decoding process. As mentioned above, the problem addressed by the present embodiment is how to increase the deblocking filter (DBF) speed in the case of multiple slices and parallel slice parsing/decoding.

The proposed solution consists of creating multiple deblocking filtering threads, and in providing each deblocking thread with some lines of decoded macroblocks to deblock. Moreover, a macroblock-based synchronisation between the deblocking threads is achieved. It ensures that the preceding neighbouring macroblocks of a given macroblock are available in their deblocked state before starting to deblock the current macroblock.

In addition, a particular issue that has to be solved in this parallel deblocking framework is that as slices are parsed/decoded in parallel, messages coming from different slice-decoding threads, which indicate available subsets of decoded macroblocks, are received out of order by the deblocking threads. This is because the parallel parsing/decoding does not necessarily complete in the same order as the slices appear in a picture.

Moreover, these messages from the decoding threads do not necessarily indicate entire lines of decoded macroblocks but rather indicate subsets of lines of macroblocks that are in a decoded state.

Therefore, it is proposed to create a particular thread, called the main deblocking thread, which is in charge of receiving all messages coming from the decoding threads, re-order them, and adapt them to indicate entire lines of macroblocks that are decoded and need to be deblocked. This functionality represents the main point of the preferred embodiment. Finally, further embodiments are proposed that address various strategies on how to redistribute the rearranged messages to subordinate deblocking threads, as a function of the desired load balancing between the parsing/decoding process on one side, and the deblocking filtering process on the other side.

FIG. 2 shows, with respect to the present invention, that a partial “intra deblock” 212 is applied in the base layer, and a full deblocking operation 214 is applied on decoded pictures of the topmost layer.

More generally, the deblocking filter in SVC is not applied in the same way in all scalability layers, and the following rules apply.
In layers preceding a change in spatial resolution, an Intra-deblocking is applied on reconstructed Intra-macroblocks.
In layers other than the topmost layer and that do not precede a spatial resolution change (hence preceding a CGS or MGS layer), no deblocking is applied.
In the topmost layer, a full deblocking filter is applied on the decoded pictures.

The present embodiment focuses on the parallel implementation of the deblocking filter.

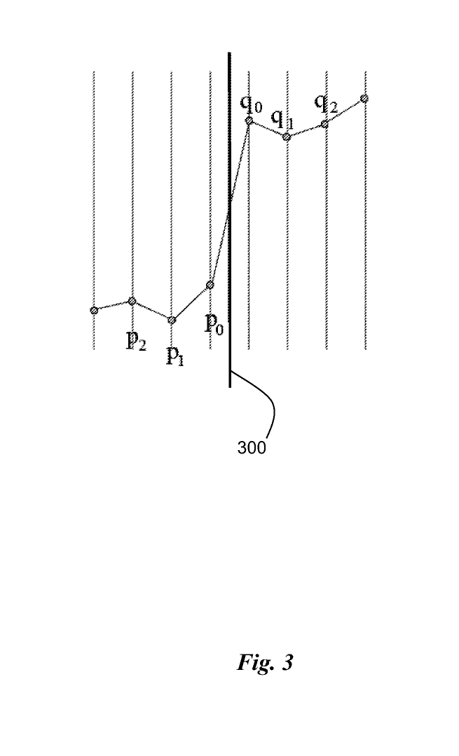

FIG. 3 illustrates the way the deblocking filter works in, for example, H.264/AVC and SVC. The goal of the deblocking filter is to attenuate the blocking artefacts that are naturally generated by block-based video codecs. In other words, the deblocking filter smoothes the sharp edges between blocks to improve the visual impact of pictures.

To reduce these blocking artefacts, an adaptive in-loop deblocking filter has been defined in H.264/AVC. It is adaptive because the strength of the filtering depends, among other things, on the values of the reconstructed image pixels. For example, in FIG. 3, the filtering along a one-dimensional array of pixels (p₂, p₁, p₀, q₀, q₁, q₂) is illustrated on either side of an edge 300 of a 4×4-pixel block. A deblocking filter may modify as many as three samples on either side of the edge of the block (such as the three samples p₀, p₁ and p₂ on the right side of the edge and q₀, q₁ and q₂ on the right side of the block edge) for high-strength filtering, though the deblocking filter is more likely to modify one or two samples to obtain a satisfactory result.

The way samples p₀ and q₀ are filtered depends on the following conditions, where a difference between samples is a difference of luminance or of chrominance between the samples:

|p₀−q₀|<α(QP) (1)

|p₁−p₀|<β(QP) (2)

|q₁−q₀|<β(QP) (3)

All of the conditions (1) to (3) are respected to filter samples p₀ and q₀. α(QP) and β(QP) are thresholds calculated as a function of the quantisation parameter QP. β(QP) is much smaller than α(QP).

Moreover, samples p₁ and q₁ are filtered if the following conditions of equation (4) are fulfilled respectively:

|p₂−q₀|<β(QP) or |q₂−q₀|<β(QP) (4)

The aim of conditions (1) to (4) is to detect real blocking artefacts and distinguish them from edges naturally present in the video source. Therefore, if a high absolute difference between samples near the frontier of a block is calculated, then it is likely to reflect a blocking artefact. However, if this absolute difference is too large, then this may not come from the coarseness of the quantisation used, and it may more reflect the presence of a natural edge in the video scene.

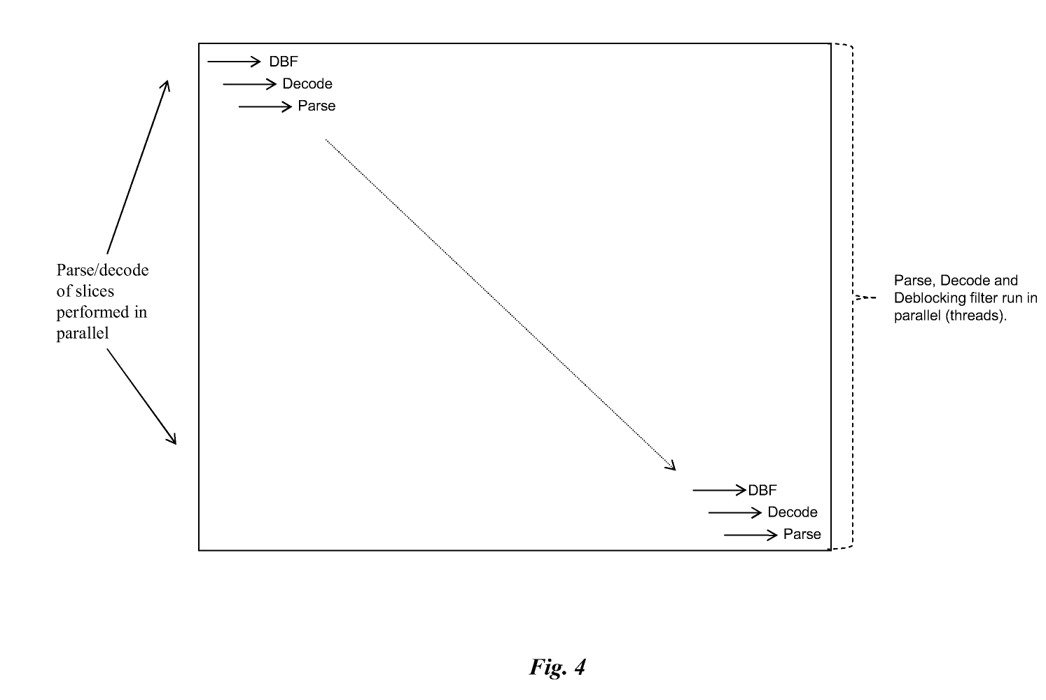

FIG. 4 illustrates an initial parallel decoding arrangement that is optimised in embodiments of the invention. FIG. 4 shows how the decoding of one given slice is working in the initial decoder. A slice is a contiguous subset of macroblocks inside a picture of a video bitstream or of a picture representation in a particular scalability layer in a scalable video bitstream. Hence a coded picture contains one or several slices.

As can be seen in FIG. 4, the decoding of slice data is organised in three different processes which run in parallel. Such parallel processes are also called threads in the following description (and are performed in “threads” of a multi-thread processor or by “cores” of a multi-core processor). These three threads are called the parsing thread, the decoding thread and the deblocking filtering thread or simply the deblocking thread. These threads are respectively in charge of the following.
The parsing thread performs the syntactic decoding of the part of the video stream that corresponds to the slice in question. In particular, this parsing includes the entropy decoding, which was already introduced with reference to FIG. 2. In the H.264/AVC standard and its SVC scalable extension, this entropy decoding takes the form of either the CAVLC (Context Adaptive Variable Length Coding) or CABAC (Context Adaptive Binary Arithmetic Coding) decoding processes.
The decoding process performs the inverse quantisation, inverse DCT, temporal or spatial prediction and reconstruction (adding prediction and residual macroblocks) of each macroblock in the slice.
As already introduced with reference to FIGS. 2 and 3, the deblocking filter performs a filtering that reduces the blocking artefacts associated with the block-based structure of any standard video decoder.

The three threads illustrated in FIG. 4 are pipelined on a line-by-line basis. This means that the decoding process waits for an entire line of macroblocks to be available in their parsed state before starting to process the line of macroblocks. Therefore, the parsing thread is always in advance compared to decoding threads by at least one line of macroblocks. In the present implementation, the decoding process is repeatedly activated by the parsing process through a dedicated message-passing mechanism.

In the same way, a pipelined arrangement exists between the decoding thread and the deblocking thread. The deblocking thread is activated to process a line of macroblocks each time two lines of macroblocks are available in their decoded state. This means the advance of the decoding thread over the deblocking thread is always greater than one line of macroblocks. Again, a message-passing mechanism is used between the decoding and the deblocking thread, to allow the decoding thread to activate the deblocking thread.

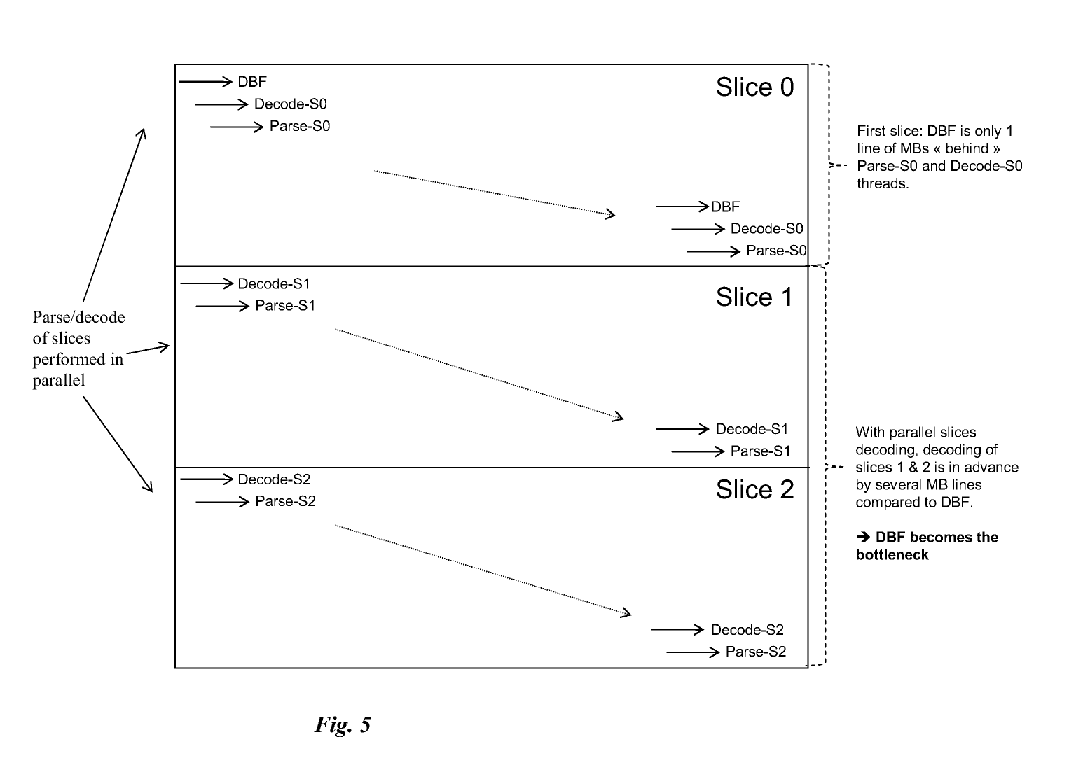

Another level of parallelism in a decoder consists of processing the slices contained in a given picture in parallel. Such parallel processing of slices is illustrated in FIG. 5. A picture made of three different slices is illustrated in FIG. 5. As can be seen, one parsing thread and one decoding thread are running in each slice. Therefore, three parsing threads, labelled Parse-S0, Parse-S1 and Parse-S2, are running in parallel, and three decoding threads, labelled Decode-S0, Decode-S1 and Decode-S2, are running in parallel. Inside each slice, the pipelined arrangement between the parsing thread and the decoding thread is employed in the same way as described with respect to FIG. 4.

With respect to the deblocking filter, the H.264/AVC decoding process dictates that the deblocking filter should apply sequentially on macroblocks over the whole picture. Hence, before deblocking a given line of macroblocks, the preceding line of macroblocks must have been decoded. As a consequence, the deblocking filtering of macroblocks contained in the second slice cannot start before the deblocking of the first slice or the first sequence of macroblocks has been finished. Similarly, the deblocking of the third slice can only start once the deblocking of the second slice is over.

As a result, the parallel processing of slices has been initially designed with one deblocking filtering thread, as illustrated in FIG. 5 and labelled DBF in the first slice.

As a result of the parallelised organisation of FIG. 5 in the multi-slice case, an increase in speed of the decoder is possible compared to a sequential processing of all slices. However, one issue remains concerning the deblocking filtering process and it is this issue which is addressed hereinbelow.

The right side of FIG. 5 depicts how the decoding process illustrated by FIG. 5 behaves in the multi-slice case.

During the processing of the first slice, three threads are running for the first slice in a pipelined way: the parsing, the decoding and the deblocking filter threads all run sequentially. As mentioned on the right side of FIG. 5, the deblocking filter progress status is from one to two lines of macroblocks “behind” that of the Decode-S0 thread.

In the meantime, while the first slice is being processed by the “Parse-S0”, “Decode-S0” and “DBF” threads, the second slice is being processed by the “Parse-S1” and “Decode-S1” threads and the third slice is being processed by the “Parse-S2” and “Decode-S2” threads.

As a consequence, once the first slice has been fully processed by the “Parse-S0”, “Decode-S0” and “DBF” threads, a significant amount of data is likely to have been processed (i.e. to be in a “decoded” state) in the second and third slices in the picture. Therefore, when the single deblocking filtering thread (DBF) starts processing the second slice, the parsing and decoding threads are both in advance by several lines of macroblocks in the second and third slices, compared to the deblocking thread. Ultimately, if the parsing and decoding threads in all slices progress at a similar speed across macroblocks, then the second and third slices may have been entirely parsed and decoded when the deblocking thread is only starting to process the second slice.

As a result, during the deblocking of the second and third slices, the deblocking thread may be the only thread working, once all other parsing and decoding threads have finished their respective work in their dedicated slice. Thus, during such a period of time, the decoder would fall into a so-called serial mode, i.e. with only one thread running. This is why, as mentioned in FIG. 5, the DBF thread becomes the speed bottleneck of the overall decoder during such a period of time.

This serial running mode of the decoder that occurs when the deblocking of each picture is being terminated significantly limits the speed of the overall decoding process. Indeed, the CPU capacity of a multi-core platform is being rather under-utilised when only one thread is working. To solve this issue, the present goal is to speed up the deblocking filtering process in the parallelised decoder implementation.

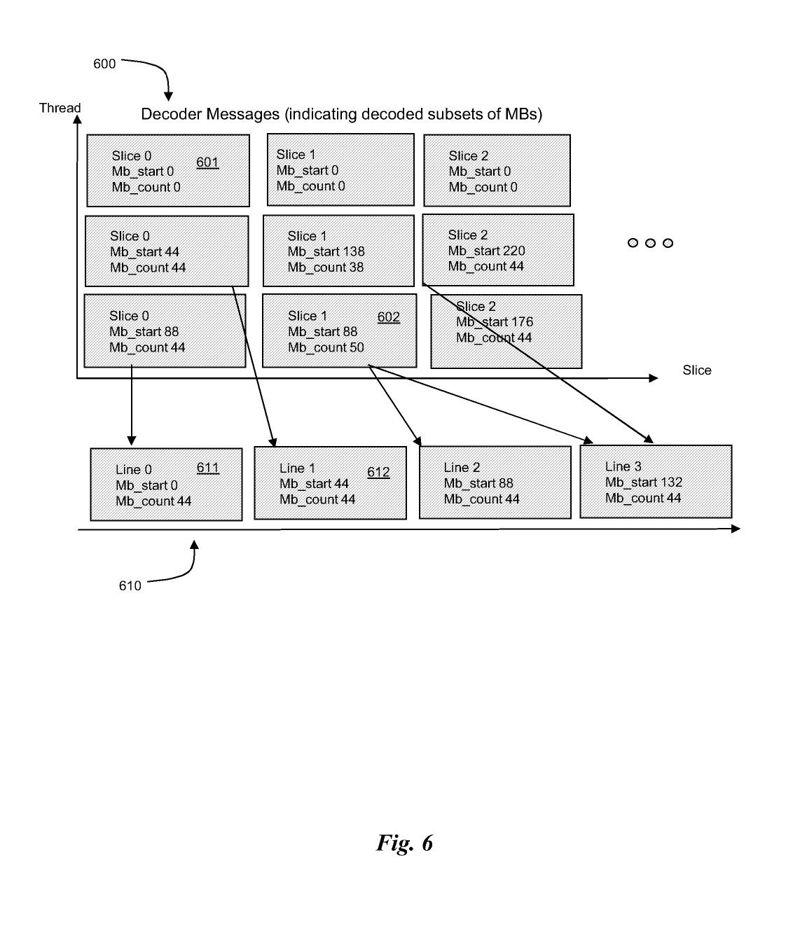

FIG. 6 illustrates the main mechanism proposed in the present embodiments so as to speed up the deblocking filtering process in the considered parallel decoder implementation. The top graph 600 illustrating decoder messages as a function of currently-decoded slice contains nine exemplary messages 601, 602, etc. Each message contains the number of the slice that has been decoded (slice 0, slice 1 and slice 2 are exemplified), the macroblock number at which the decoding started within the respective slice (labelled Mb_start), and the number of macroblocks decoded (Mb_count) from the starting macroblock for that group of macroblocks. For example, message 601 is at slice 0 and no macroblocks have been decoded. On the other hand, message 602 shows that the decoded macroblocks are in slice 1, start at the 88th macroblock in the slice and that 50 macroblocks have been decoded.

An embodiment includes parallelising the deblocking filtering process in the decoder. This parallelisation, according to a preferred embodiment, involves one master (or main) deblocking filter thread and several slave (or subordinate) deblocking threads. The master deblocking filter thread is in charge of receiving various messages 601, 602, etc., coming from different decoding threads, respectively dedicated to the decoding of their own slice. Each message indicates the concerned slice index (0, 1, 2), together with a group of macroblocks (Mb_start, Mb_count) that has been processed by the decoding thread. As the decoding threads run in parallel without any synchronisation between them, messages from different decoding threads arrive out of order to the main deblocking filter thread (not illustrated).

The constraint imposed by the H.264/AVC standard concerning the deblocking filtering process is the following one: a macroblock can be deblocked when its right, top-left, top and top-right neighbouring macroblocks have been deblocked. Specifically, lines of macroblocks must be processed in order by the deblocking filtering process according to this standard.

Therefore, the main deblocking thread performs a re-ordering of incoming messages from various decoding threads so that they are in sequential order and able to be deblocked.

A further complication arises because the macroblock groups signalled in incoming messages do not necessarily correspond to exact entire lines of macroblocks. This can be seen in the variety of numbers and start positions of the decoded macroblocks referred to in the messages 601, etc., of FIG. 6. The reason for this is that slice boundaries are not necessarily aligned with macroblock lines, and also that some macroblocks are skipped in the decoding process (e.g. if their value is zero). Indeed, only non-skipped macroblocks are treated by decoding threads and are marked as “decoded” in the corresponding message.

As a consequence, since all macroblocks in the picture are to be deblocked, the main deblocking filter generates new output messages that indicate entire lines of macroblocks. These messages are shown in the bottom line of FIG. 6 and are labelled 610. For example, new output message 611 is in line 0, starts at macroblock 0 and contains 44 decoded macroblocks. This represents a full line. The next message is preferably the next line containing the next macroblocks in the sequence of the picture being decoded. Thus, the next message 612 is for line 1, starts at macroblock 44 (where the zeroth line is left off) and again contains 44 decoded macroblocks, which is the number of macroblocks in a line.

As a result of this, the macroblock boundaries in these new output messages are no longer linked to the slice structure of the picture.

Each output message including this information regarding the processed macroblocks is then forwarded to a deblocking filter thread, chosen among a pool of potentially several active subordinate deblocking filter threads. The number of deblocking filter threads depends on the number of cores available in the multi-core processor taking into account the number being used by the decoding processes. Alternatively, the system could be a software-implemented multi-threaded system that can be compared to a multi-core system with virtual cores.

The subordinate deblocking threads are then in charge of performing the actual deblocking filtering process on decoded macroblocks.

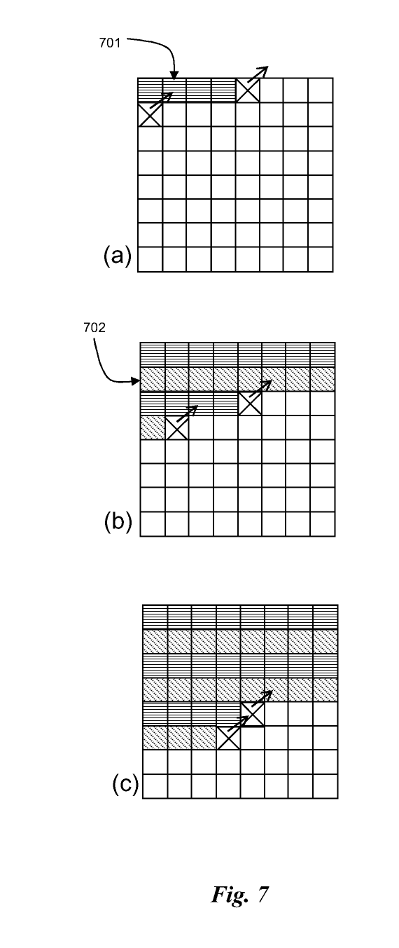

As previously mentioned, in the H.264/AVC standard, a macroblock can be deblocked when its left, top-left, top and top-right neighbouring macroblocks have been deblocked. FIG. 7 illustrates the parallelised deblocking filter as performed in this invention, in the case of there being two subordinate deblocking threads.

In FIG. 7, horizontally-striped macroblocks 701 are macroblocks processed by the first subordinate deblocking thread, and diagonally-striped macroblocks 702 are processed by the second subordinate deblocking thread.

The two subordinate deblocking threads run in parallel but must respect the above mentioned H.264/AVC dependency rule. As a consequence, as illustrated by FIG. 7, before processing a given macroblock, each subordinate deblocking thread checks that its top-right neighbouring macroblock has been deblocked. This is sufficient to respect the above dependency rule, since all macroblocks in all lines are processed from left to right. If the top-right neighbour has not been deblocked, then the subordinate thread in question waits until it has been deblocked.

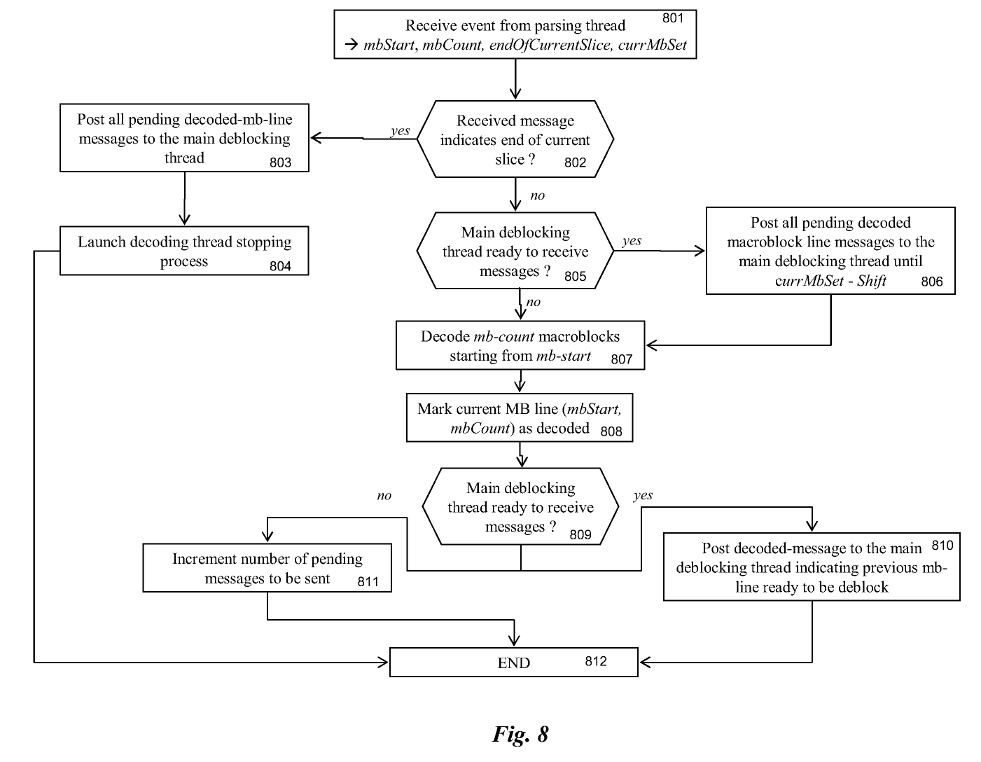

FIG. 8 is a flowchart illustrating the processes of an algorithm that defines the functioning of the decoding threads that precede the main deblocking thread proposed herein in the overall picture decoding process.

Thus, the algorithm of FIG. 8 corresponds to a part of the global slice decoding process. One instance of the decoding thread is executed for each slice of a given picture.

The first step 801 of the algorithm of FIG. 8 consists of receiving a message that indicates a set of macroblocks that have been parsed (mbStart, mbCount), together with the index currMbSet of the received message, which is an index of the current macroblock set. This message is typically received from the parsing thread previously introduced with reference to FIGS. 4 and 5. This message may also indicate that all macroblocks in current slice have been decoded (endOfCurrentSlice), which would mean that the decoding step in current slice is done.

The next step 802 of the algorithm checks if the received message indicates the end of current slice. If this test is positive (yes in step 802), then a stopping procedure 803, 804, 812 of the decoding process is invoked. This stopping procedure first consists of sending 803 a message to the main deblocking thread for each decoded line of macroblocks which is not yet been signalled to the main deblocking thread. Indeed, the decoding thread may be in advance over the main deblocking thread by several lines of macroblocks in the parallelised decoder. Therefore, it is preferable to signal each decoded line of macroblocks to the main deblocking thread. Next, the second step 804 of the stopping procedure consists of activating the stopping of the current decoding thread. Once this is done, the algorithm of FIG. 8 is over in step 812.

Returning to the test 802 on the end of the current slice, if the incoming message from the parsing thread does not indicate the end of current slice (no in step 802), then the interval of macroblocks (mbStart, mbEnd) indicated in the input message is going to be processed by the rest of the algorithm of FIG. 8.

This first step 805 of the rest of the algorithm consists of testing if the main deblocking thread is ready to receive messages indicating decoded subsets of macroblocks. Indeed, one parallel H.264/AVC decoding strategy may consist of postponing the start of the deblocking filtering process, based on the assumption that the decoding process is slower than the deblocking process. In such case, it may be of interest to make the decoder process several lines of macroblocks before activating the deblocking filtering process. If the test is positive (yes in step 805), then all pending messages indicating subsets of decoded macroblocks are posted 806 to the main deblocking thread, up to the subset with identifier currMbSet-Shift, where Shift represents the preferred “advance” (or “head start”) for the decoding thread to have over the main deblocking thread.

Once all pending output messages have been from the decoding thread to the deblocking thread, the algorithm of FIG. 8 goes to next step. The next step 807 consists of performing the actual decoding of macroblocks of which the address is between mbStart and mbEnd. Once this is done, the current set of macroblocks is marked as decoded in step 808. This way, a message ready to be sent to the main deblocking thread is created.

The next step 810 of the algorithm consists of sending the thus-created output message to the main deblocking thread, if it is ready 809 to receive incoming messages. If not (no in step 809), the message that has just been created is stored, and the number of pending messages to be sent is incremented in step 811. Similarly, if the subordinate deblocking filter threads are not available to deblock the decoded block, the main deblocking filtering thread may arrange for the messages to be stored until a subordinate becomes available.

Once this processing of the created output message is done, the algorithm of FIG. 8 is over 812.

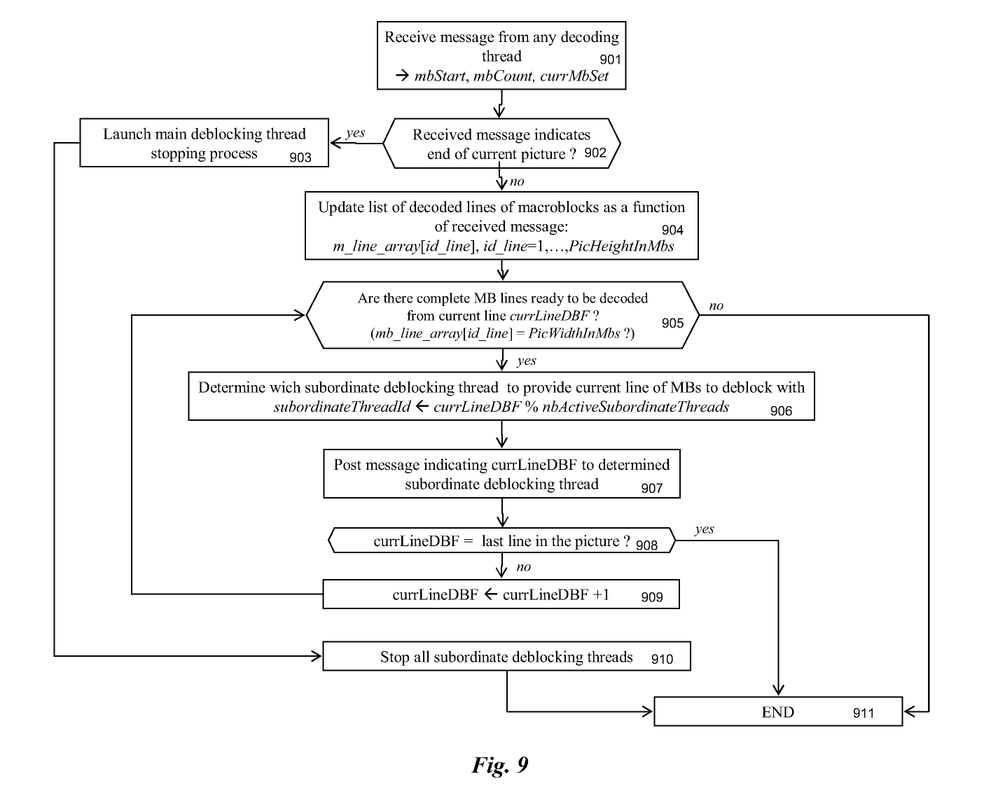

The algorithm of FIG. 9 describes the functioning of the main deblocking filtering thread. The input to this algorithm consists of a message received from any decoding threads running in the current picture. Thus, the first step 901 of the algorithm of FIG. 9 consists of receiving the input message from a decoding thread. This message indicates the concerned interval of macroblocks (mbStart, mbCount) together with the identifier currMbSet of this macroblock set. In addition, the input message may indicate that all macroblocks in a current picture have been processed.

The next step 902 checks if the end of current picture is signalled in the received message. In this case, the algorithm of FIG. 9 launches a deblocking thread stopping procedure, which consists of stopping 903 the main deblocking thread and stopping 910 the subordinate deblocking threads. Once this procedure is done, all deblocking threads are stopped and the algorithm of FIG. 9 is over 911.

In case where the end of current picture is not yet reached (no in step 902), the algorithm of FIG. 9 processes the subset of macroblocks signalled in the incoming message in the way already illustrated in FIG. 6. More precisely, the received subset of macroblocks indicated in the input message is integrated 904 into a list of complete lines of decoded macroblocks progressively constructed by the algorithm of FIG. 9.

As there are an integer number of lines in a picture, the way that the line in question is updated is by allocating it a value of 1 to PicHeightinMbs—i.e. to the maximum height of the picture in units of macroblocks.

This integration (or merging) process 904 updates the list which represents the output message of the main deblocking thread illustrated in FIG. 6. Each element mb_line_array[id_line] for a particular line index id_line indicates the number of macroblocks in line id_line that are in decoded state, thus that are ready to be deblocked.

The next step 905 of the algorithm of FIG. 9 tests if there are complete lines of macroblocks in a decoded state starting from current line currLineDBF. Reaching the end of the line would give a value of PicWidthInMbs; i.e. picture width in units of macroblocks (since a line extends across the width of a picture). The position in the line is called mb_line_array[id_line], the maximum of which is PicWidthInMbs.

Index currLineDBF represents the index of the next line to be deblocked. In other words, lines of macroblocks from 0 to currLineDBF-1 have already undergone the deblocking filter process. Therefore, if current line currLineDBF is ready to be deblocked (i.e. if m_line_array[currLineDBF] is equal to the picture width in macroblocks PicWidthInMbs) then the line of macroblocks currLineDBF is sent to be deblocked. To do so, the algorithm of FIG. 9 determines 906 which subordinate deblocking thread is to be allocated for this task. In the embodiment of FIG. 9, this subordinate deblocking thread indexed subordinate ThreadId is chosen through an integer division known as a “modulo” operation shown in step 906 of FIG. 9, namely the subordinate deblocking thread subordinate ThreadId that is allocated is based on the number of available subordinate threads represented by currLineDBF%nbActiveSubordinate Threads.

Then the algorithm of FIG. 9 posts 907 a message so as to distribute a current line of macroblocks currLineDBF to the selected subordinate deblocking thread with index subordinate ThreadId. Once this is done, the algorithm tests 908 if current line currLineDBF is the last line of macroblocks in the picture. If not, the current line of macroblocks being considered is updated 909 by incrementing by one its index currLineDBF. Then the algorithm loops to the testing step 905 previously explained. If the test 908 on the last line is positive (yes in step 908), then the algorithm of FIG. 9 is over 911.

Finally, when the test on the complete lines of macroblocks ready to be deblocked was negative, i.e. when lines of macroblocks starting from currLineDBF are not yet ready to be deblocked (no in 905), then the algorithm of FIG. 9 is over.

According to the preferred embodiment described with respect to FIG. 9, the lines of macroblocks are sent to the deblocking filter threads from the top to the bottom of a picture. This is the preferred case when the number of deblocking threads is limited. In this case, the ordering of the messages occurs so that the lines are sent to the deblocking threads in this correct order. On the other hand, when the number of deblocking threads is not as limited, then it is not as important to send the messages in a particular order and so the ordering step may be omitted.

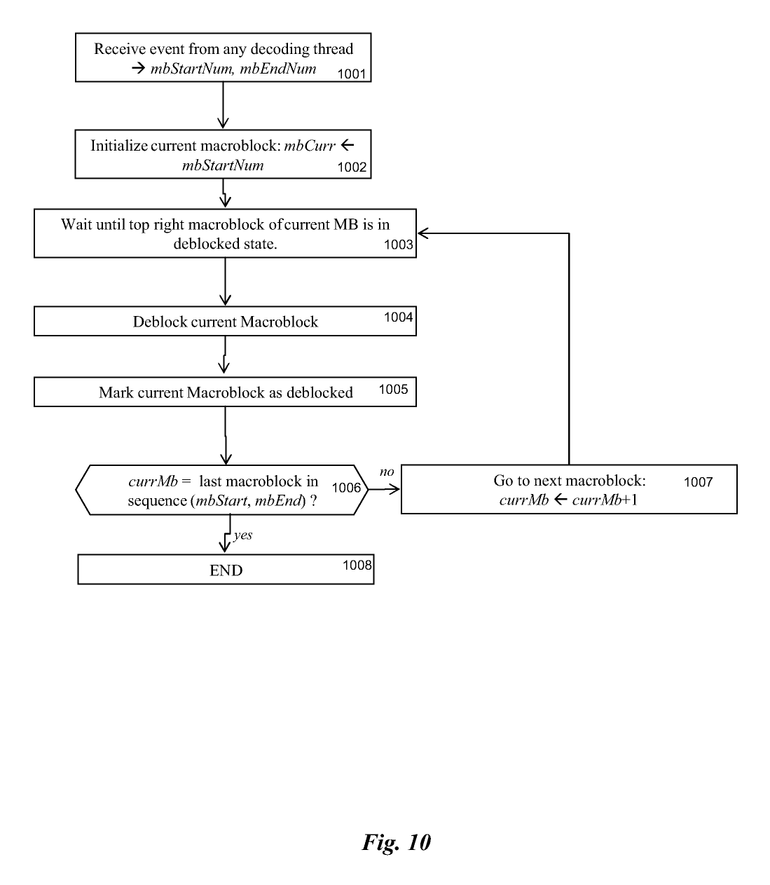

FIG. 10 illustrates the message-ordering step. This deblocking ordering is performed at macroblock level.

More specifically, FIG. 10 provides an algorithm that describes the functioning of the subordinate deblocking threads. The input to this algorithm consists of a message received from the main deblocking thread, previously described with reference to FIG. 9. The first step 1001 of the algorithm of FIG. 10 consists of receiving the set of macroblocks (defined by start mbStartNum and end mbEndNum macroblock numbers) that the current deblocking thread is allocated to process. The next step 1002 initialises the current macroblock index to the starting value mbStartNum. The current macroblock being considered by the algorithm of FIG. 10 is labelled mbCurr.

The next step 1003 consists of waiting until the top-right neighbouring macroblock of macroblock mbCurr has been processed by a subordinate deblocking thread. The goal of this waiting step is to ensure the macroblock-based synchronisation between deblocking threads, which has been explained with reference to FIG. 7.

Once the top-right neighbour of current macroblock is marked “deblocked”, then the current subordinate deblocking thread is allowed to process 1004 to the current macroblock currMb. Therefore, the current macroblock is deblocked. Once it is deblocked, it is marked 1005 as “deblocked”.

The next step 1006 consists of testing if current macroblock is the last one in macroblock interval (mbStart, mbEnd). If this is the case (yes in step 1006), then the algorithm of FIG. 10 is over 1008. Otherwise, the algorithm increments 1007 the current macroblock index by one and returns to the waiting step 1003 previously explained.

The present embodiment thus enables a processor to reduce sequential decoding tasks considerably and to carry out deblocking filtering tasks in parallel while respecting SVC (or H.264/AVC, where the SVC specification is not used in coding the video data) constraints.

The flowcharts of FIGS. 8, 9 and 10 illustrate one embodiment of the functioning of the present invention. However, the skilled person would be able to implement the basic invention with different approaches while respecting the SVC specifications.

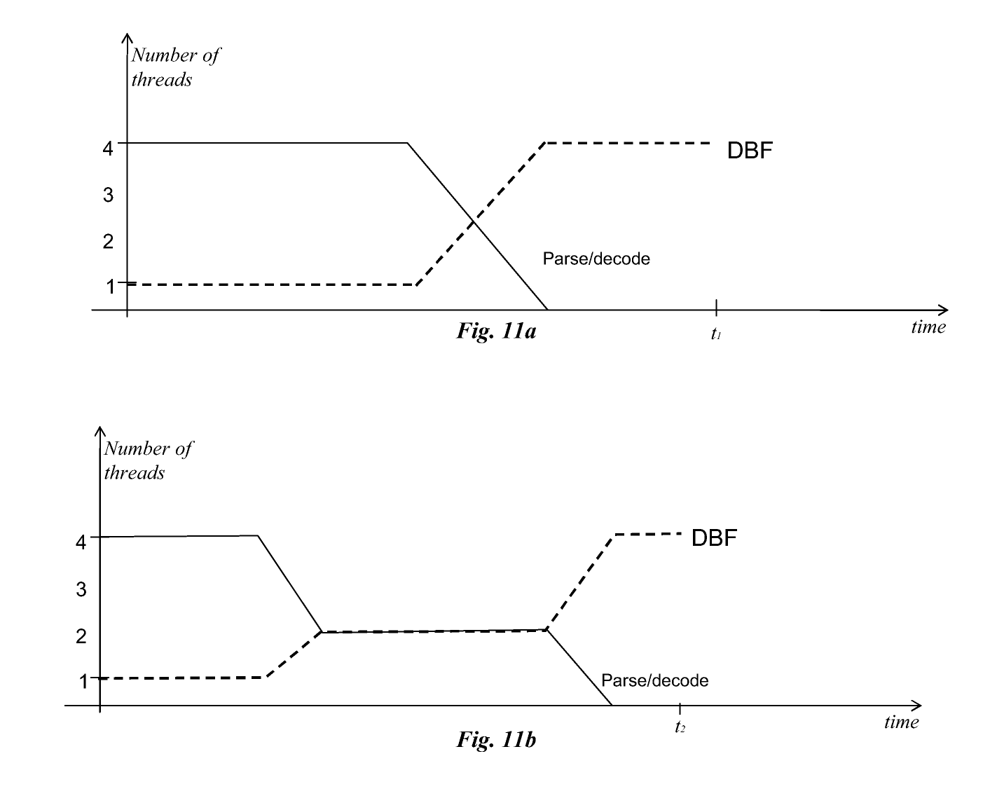

FIGS. 11a and 11b illustrate additional embodiments of the present invention. In particular, in the algorithm of FIG. 9, a fixed number of active subordinate deblocking threads has been considered. This number was represented by the quantity nbActiveSubordinate Thread in step 906 of FIG. 9.

As has been explained, using a fixed number of active deblocking threads that is greater than one is useful in order to accelerate the overall deblocking filtering process. By comparison, the deblocking filtering process was only handled by one thread in the case of FIG. 5, which represented the initial state of the decoder. This acceleration is particularly noticeable during the period of time when the parsing and decoding of various slices in the picture are finished and the deblocking filtering is not continuing on its own in a single thread.

However, given the multi-threaded decoder functioning as illustrated in FIG. 5, when the first slice of the picture is being parsed and decoded, then the deblocking thread is only behind the parsing and decoding threads “Parse-S0” and “Decode-S0” by one or two lines of macroblocks. Therefore, during that period of time, the deblocking process may not be the speed bottleneck of the overall system at all. Therefore, having several subordinate deblocking threads may not provide any speed benefit during that first period of time in the picture decoding process. On the other hand, it would lead to configurations where several subordinate deblocking filtering threads are often waiting for each other, until macroblocks are ready to be deblocked.

FIG. 11a and FIG. 11b thus propose advanced embodiments of the proposed invention, where the number of activate subordinate deblocking filtering threads varies as a function of the time. FIG. 11a shows an example in which the number of active subordinate deblocking filtering threads is initialised to one thread during the beginning of the picture decoding process. In the meantime, the number of active threads for parsing and decoding is much greater—say three in a four-core processor. At a time when one or several slices in the picture are completely parsed and decoded such that not all threads are needed for parsing and decoding, then having only one single deblocking thread would lead to a speed penalty. Hence, there is proposed an increase in the number of active subordinate deblocking threads, as long as the number of completely “parsed” and “decoded” slices is still maintaining its lead over the deblocking thread for the picture in question. In the example of FIG. 11a, the number of threads allocated to deblocking (DBF) increases as the number of threads allocated to parsing and deblocking decreases once the parsing and decoding are coming to an end for the current picture. In this case, it can be seen that the deblocking carries on for some time (up to time t₁) after the parsing and decoding has finished.

In the example of FIG. 11b, on the other hand, although there are more threads allocated to parsing and decoding at least for the first slice than to deblocking, when deblocking cannot occur anyway, the number of threads allocated to parsing and decoding drops off earlier than in the example of FIG. 11a so that the number of threads available for deblocking may increase. In this way, although it takes slightly more time to complete the parsing and decoding for the entire picture, the deblocking is finished not long afterward, at time t₂, such that the total time taken t₂ is less than the time taken t₁ in the example of FIG. 11a.

The number of active subordinate deblocking threads may be defined by the total number of cores present on the multi-core parallel platform, as illustrated on the y-axis of FIGS. 11a and 11b.

The skilled person may be able to think of other modifications and improvements that may be applicable to the above-described embodiment. For example, although the present invention is best applied to a picture with multiple slices (as the deblocking filter preferably waits for a slice to have been parsed and decoded before deblocking a line from that slice), a video bitstream divided into grouped slices may also benefit from the message-passing mechanism and reordering method of the present invention. As in the cases described above, the deblocking would be performed according to lines and independently of the groupings of the slices.

The present invention is not limited to the embodiments described above, but extends to all modifications falling within the scope of the appended claims.

1. A deblocking filter for deblocking a decoded video bitstream comprising a plurality of pictures, each picture comprising a plurality of lines of blocks, the blocks having a predefined sequence, the deblocking filter comprising:
a plurality of deblocking filter units;
receiving means for receiving information indicating that a plurality of blocks have been decoded;
ordering means for ordering the received information according to the predefined sequence of the blocks;
distribution means for generating a plurality of messages indicating the order of the ordered, received information and for distributing the messages amongst the deblocking filter units; wherein
the plurality of deblocking filter units are configured to deblock the decoded blocks according to the order of the ordered, received information indicated in the messages.

2. A deblocking filter according to claim 1, wherein the distribution means is configured to distribute the messages to the deblocking filter units only when the receiving means has received information indicating that a full line of blocks has been decoded and when the ordering means has ordered the received information for the full line of blocks.

3. A deblocking filter according to claim 1, comprising a main deblocking filter unit and at least one subordinate deblocking filter unit, the main deblocking filter unit including the receiving means, the ordering means and the distribution means and being configured to distribute the messages to the active subordinate deblocking filter units, each of which is configured to deblock a sequence of blocks according to a received message.

4. A deblocking filter according to claim 3, wherein the number of active subordinate deblocking filter units is variable.

5. A deblocking filter according to claim 4, wherein the number of active subordinate deblocking filter units is dependent on a number of cores available in a multi-core processor.

6. A deblocking filter according to claim 3, wherein, when a subordinate deblocking filter unit is not available, the main deblocking filter unit is configured to store the messages until a subordinate deblocking filter unit becomes available.

7. A deblocking filter according to claim 1, wherein the information that is received by the receiving means comprises decoder messages from a decoder that has decoded the blocks, the decoder messages containing at least a number of blocks decoded and location in a picture of the decoded blocks, and wherein the ordering means is configured to order the decoder messages in a sequence according to the location in the picture of the decoded blocks.

8. A deblocking filter for deblocking a decoded video bitstream comprising a plurality of pictures, each picture comprising a plurality of blocks, the deblocking filter comprising:
a plurality of deblocking filter units;
receiving means for receiving information indicating that a plurality of blocks have been decoded; and
distribution means for determining whether a predetermined number of blocks have been decoded and for distributing, amongst at least one of the plurality of deblocking filter units, messages regarding deblocking the decoded blocks when it is determined that all blocks of the predetermined number of blocks have been decoded; wherein
the plurality of deblocking filter units are configured to deblock the decoded blocks according to the distributed messages.

9. A deblocking filter according to claim 1, wherein each picture comprises a plurality of lines of blocks and the predetermined number of blocks comprises a line of blocks.

10. A decoder for decoding a video bitstream comprising a plurality of pictures each comprising lines of blocks, the decoder comprising:
a plurality of decoder units configured to carry out a plurality of decoding tasks on said blocks in parallel;
determining means for determining when a plurality of blocks have been decoded by at least one of the plurality of decoder units;
transmission means for transmitting information regarding the blocks that have been decoded to a deblocking filter; and
a deblocking filter according to claim 1.

11. A decoder according to claim 10, wherein the plurality of decoder units are configured to create the information that is transmitted by the transmission means, the information comprising messages that indicate at least a number of blocks that have been decoded and a location in a picture of the decoded blocks.

12. A decoder according to claim 10, wherein the decoding units and the deblocking filter units use cores in a multi-core processor for performing decoding tasks and deblocking respectively, and the decoder further comprises:
allocation means for allocating each active core to either a decoding unit or a deblocking filter unit in accordance with a number of blocks that remain to be decoded or deblocked respectively.

13. A decoder according to claim 10, wherein the blocks are macroblocks.

14. A decoder according to claim 10, adapted to decode a video bitstream that is encoded according to a scalable format comprising at least two layers, the decoding of a second layer being dependent on the decoding of a first layer, said layers being composed of said blocks and the decoding and deblocking of at least one of said blocks being dependent on the decoding and deblocking of at least one other block, wherein
the distribution means is configured to distribute messages to the deblocking filter units in an order dependent on the decoded blocks being in the same layer.

15. A decoder according to claim 10, wherein the decoder is an SVC decoder.

16. A method of deblocking a decoded video bitstream comprising a plurality of pictures each comprising lines of blocks, the blocks having a predefined sequence in each line, the method comprising:
receiving information indicating that a plurality of blocks have been decoded;
ordering the received information according to the predefined sequence of blocks in a line;
generating messages indicating the order of the ordered, received information;
distributing the messages amongst at least two deblocking filter units; and
deblocking the decoded blocks using the at least two deblocking filter units based on the order indicated in the messages.

17. A method of deblocking a decoded video bitstream comprising a plurality of pictures each comprising a plurality of blocks, the method comprising:
receiving information indicating that a plurality of blocks have been decoded;
determining whether a predetermined number of blocks have been decoded;
generating messages regarding deblocking the decoded blocks when it is determined that all blocks of the predetermined number of blocks have been decoded;
distributing the messages amongst at least two deblocking filter units; and
deblocking the sequence of blocks according to the messages.

18. A method according to claim 17, wherein each picture comprises a plurality of lines of blocks and the predetermined number of blocks comprises a line of blocks.

19. A method of decoding a video bitstream comprising a plurality of pictures each comprising lines of blocks, the blocks having a predefined sequence in each line, the method comprising:
performing a plurality of decoding tasks on said blocks in parallel;
generating information indicating that a plurality of blocks have been decoded;
ordering the information according to the predefined sequence of blocks in a line;
distributing messages regarding the decoded blocks that form the predefined sequence amongst at least two deblocking filter units;
deblocking the sequence of blocks in the at least two deblocking filtering units.

20. A computer program product comprising executable instructions which, when run on a computer, cause the computer to perform the method of claim 16.

21. A non-transitory storage medium having stored thereon a computer program product according to claim 20.
